(19) United States
(12) Patent Application Publication
(10) Pub. No.: US 2012/0019147 A1
(43) Pub. Date: Jan. 26, 2012

(54) DIMMABLE COMPACT FLUORESCENT LIGHTING DEVICE

(76) Inventor: Leo Zhang, XinPing City (CN)

(21) Appl. No.: 12/841,175

(22) Filed: Jul. 22, 2010

(51) Int. Cl. H05B 41/36

(52) U.S. Cl. 315/127

(57) ABSTRACT

A dimmable compact fluorescent lighting device includes a safety protection circuit, an electro-magnetic compatibility (EMC) circuit, a rectification and filter circuit, a power factor correction circuit, a trigger circuit, a switching and anti-saturation circuit, a resonant circuit, and a filament pre-heating protection circuit. Alternate current from an electric main is chopped by a thyristor to form a non-sinusoidal voltage that, after passing through the EMC circuit, is subjected to rectification and filtering and fed through the power factor correction circuit for correction of the non-sinusoidal voltage and suppress of high order resonant waves, so as to supply a stable DC working voltage to a subsequent stage. Two transistors are used to alternate conduct so as to generate oscillation, which induces a high frequency sinusoidal AC voltage supplied through an electronic ballast to drive a lighting tube to emit light.

### (A) TECHNICAL FIELD OF THE INVENTION

The present invention generally relates to a dimmable compact fluorescent lighting device, and more particularly to a device that is applicable to compact fluorescent lighting in a manner of stepless dimming for varying lighting environment to suit the needs of commercial and household lighting.

### (B) DESCRIPTION OF THE PRIOR ART

The technology of compact fluorescent lamp (CFL) has been in development for more than ten years and gets mature recently. Particularly, the performance of and the material used for the CFL are both properly improved, making CFL attractive for commercial and household lighting. With the popularization and wide use of this type of lighting, the senses of layer and variation of lighting environment are now under a new trend for the desire of light dimming. It is known that the existing CFLs are marked with the caution of “not for use with dimmers”. This is simply because a conventional CFL is composed of several major components, including a plastic body, an electrical discharge tube, and an electronic ballast. An electronic ballast comprises a regular half-bridge driving circuit, which is of a simple circuit structure and low power factor. With working with a dimmer, the ballast shows a discontinuous output signal and a large peak current and it shows blinking at a high level of the dimmer but does not work for low and intermediate levels of the dimmer. Due to such defects, all the manufacturers make such a mark of being not for use with dimmers for CFL products.

### SUMMARY OF THE INVENTION

The present invention provides a dimmable compact fluorescent lighting device, which overcome the deficiency of an existing compact fluorescent lamp that does not work with a dimmer so that the drawback of the conventional compact fluorescent lamp that does not work with a dimmer is removed and the compact fluorescent lamp can operate in a stepless dimming manner similar to an incandescent bulb and the compact fluorescent lighting device of the present invention is of wider application than the conventional compact fluorescent lamps.

The principle of the dimmable compact fluorescent lighting device according to the present invention is to connect the dimmable compact fluorescent lighting device and a thyristor based dimmer to a power supply circuit so that through control of the conduction angle of the thyristor, the sinusoidal voltage supplied from the power supply is chopped partially to vary the supply voltage of a half-bridge inverter of the dimmable compact fluorescent lighting device. Since the device current of the dimmable compact fluorescent lighting device and the supply voltage of the half-bridge inverter are in proportion, varying the conduction angle of the thyristor of the dimmer means changing the supply voltage of the inverter of the lighting device and thus changing the device current and eventually changing the device power and the output lighting. This is the operation principle of the dimmable compact fluorescent lighting device according to the present invention.

The dimmable compact fluorescent lighting device according to the present invention comprises a safety protection circuit, an electro-magnetic compatibility (EMC) circuit, a rectification and filter circuit, a power factor correction circuit, a trigger circuit, a switching and anti-saturation circuit, a resonant circuit, and a filament pre-heating protection circuit.

The operation of the dimmable compact fluorescent lighting device according to the present invention includes an initiation process and a dimming process. The initiation process is performed in such a way that a non-sinusoidal voltage obtained by chopping operation of a thyristor is applied through the EMC circuit and then subjected to rectification and filtering so as to make a voltage across two ends of a capacitor reaching a break-over voltage of a bi-directional diode to satisfy conduction conditions of a transistor, whereby a primary side of a transformer causes a secondary side to discharge to ground, making the transistor cut off immediately after being put into conduction, the capacitor being charged again, electrical charging flowing from an emitter of a first transistor to the transformer primary side, showing a low potential and satisfying conduction conditions of the first transistor, and then cut off due to rise of the emitter potential. A collector of a second transistor shows a positive potential and due to the transformer is charged again, the second transistor satisfies the conduction conditions again and get conducting. The repeated positive feedback causes an alternate current to flow through the primary side of the transformer and induction voltages are induced in two secondary sides to force the first and second transistors to alternately conduct thereby generating oscillation. When the oscillation frequency gets identical to the natural frequency of a capacitor and a resistor, resonance is induced, which generates a high resonance voltage to start up a lighting tube. This completes the initiation process.

The dimming process of the dimmable compact fluorescent lighting device according to the present invention is performed in such a way that when the conduction angle of the thyristor of the dimmer, the sinusoidal waves of the input power is chopped and the output voltage is lowered so that the average thereof varies in a linear form. Since the supply voltage of the half-bridge inverter circuit can be set extremely low, the working condition of zero voltage switching (ZVS) can be maintained in a wide power range.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a circuit diagram of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

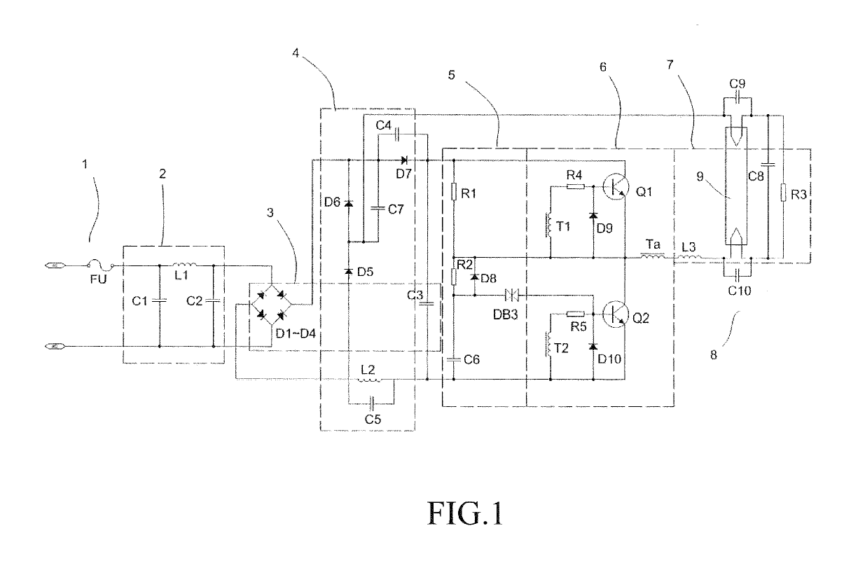

The present invention provides a dimmable compact fluorescent lighting device. As shown in FIG. 1, the dimmable compact fluorescent lighting device according to the present invention comprises the following components/parts, including:

A safety protection circuit 1 is connectable to an input line and is composed of a fuse FU.

An electro-magnetic compatibility (EMC) circuit 2 is composed of two capacitors C1, C2 and a first inductor L1 to render the device electro-magnetic compatibility and also for suppressing high order harmonic waves induced in a dimming process.

A rectification and filter circuit 3 is composed of bridge rectifiers D1-D4 and a third capacitor C3.

A power factor correction circuit 4 is composed of three diodes D5, D6, D7, three capacitors C4, C7, C5, and an inductor L2, and functions for increasing power factor, reducing peak current level, and also suppressing blinking occurring in a dimming process.

A trigger circuit 5 is composed of two resistors R1, R2, a sixth capacitor C6, an eighth diode D8, a bi-directional diode DB3.

A switching and anti-saturation circuit 6 is composed of two transistors Q1, Q2, a ninth diode D9, a tenth diode D10, two resistors R4, R5, and a transformer T1, T2, Ta, wherein the transistors Q1, Q2 include anti-saturation circuitry.

A resonant circuit 7 is composed of a third inductor L3, an eighth capacitor C8, and a third resistor R3.

A filament pre-heating protection circuit 8 is composed of two capacitors C9, C10 and a third resistor R3.

The operation of the device according to the present invention includes an initiation process and a dimming process.

(1) The initiation process is performed as follows: A non-sinusoidal voltage that has been chopped by a thyristor is applied through the fuse FU and the EMC circuit 2 and then subjected to rectification and filtering by the circuit 3 to provide a direct-current (DC) of a half-bridge inverter circuit. The direct current of the trigger circuit 5 flows through the resistors R1, R2 to charge the sixth capacitor C6. When the voltage across opposite terminals of the sixth capacitor C6 reaches a break-over voltage of the bi-directional diode DB3, the bi-directional diode DB3 conducts, making the second transistor Q2 satisfying conduction conditions thereof and thus triggered into conduction. At this time, the transformer primary side Ta discharges through the secondary side T2 to ground. Due to the eighth diode D8, the second transistor Q2 is immediately cut off at the time when it is put into conduction, and the sixth capacitor C6 is charged again. The emitter of the first transistor Q1 supplies electrical charges that flow to the transformer primary side Ta, showing a low potential and thus satisfying conduction condition, and afterwards. The first transistor Q1 gets cut off due to the rise of emitter potential and the collector of the second transistor Q2 shows a positive potential. Due to the re-charge of the sixth capacitor C6, the second transistor Q2 again satisfies the conduction conditions and gets conducting. This repeated feedback operation makes an alternative current flowing through the transformer primary side Ta and the secondary sides T1, T2 induce induction voltages, forcing the two transistors Q1, Q2 to alternately conduct to induce oscillation. When the oscillation gets a frequency, which when becoming identical to the natural frequency of the third inductor L3 and the eighth capacitor C8 of the resonant circuit 7, induces a resonance, whereby a high resonance voltage is generated to start up the lighting tube. This completes the initiation process.

(2) The dimming process is performed as follows: When the conduction angle of the thyristor of the dimmer is varied, the sinusoidal wave of the input power is chopped and the output voltage is reduced and showing an average value that varies in a linear form. In other words, the input power supplied to the dimmable CFL, which, after rectification, is supplied as direct current to the internal half-bridge inverter circuit, is of a linear variation. Since the supply voltage of the half-bridge inverter circuit can be set very low, the working condition of zero voltage switching (ZVS) can be maintained in a wide power range.

The ballast circuit according to the present invention adopts the following design to ensure linear variation and stability of the output stage and the input stage.

(A) The input filter circuit (namely the EMC circuit composed of C1, C2, and L1). Due to the breakup of the sinusoidal waveforms, circuits generate therein many high order resonant waves, which cause high frequency interference. The input circuit suppresses the high frequency interference and also suppresses blinking caused by discontinuity of the electrical current through the inductor L3 resulting from low voltage, thereby improving reliability and stability.

(B) The power factor correction circuit (D5, D6, D7, C4, C7, C5, and L2). At the intermediate and low levels of the dimmer, the circuits generate many high order resonant waves. Since the voltage and current of the high order resonant wave do no work and generate reactive power, leading to lowered utilization of power and lowered power factor. The passive power factor correction circuit shows the functions of increasing circuit power level, reducing peak current, and reducing blinking caused by excessively high peak current, to thereby improve linearity of output.

(C) The anti-saturation circuit (Q1, Q2 having internally integrated anti-saturation circuitry). With the raising or dropping of the voltage supplied from the half-bridge circuit, the driving current for the bases of the switching devices (transistors Q1, Q2) vary according to the level of the feedback current. The delay time of the transistors Q1, Q2 is affected by the level of saturation and the more saturated, the longer the delay time. The access time is controlled by the built-in active anti-saturation circuitry inside the transistors Q1, Q2 in order to shorten the access time.

(D) The filament pre-heating protection circuit 8. The lifespan of the cathode directly affects the lifespan of the CFL, so that the electronic ballast is vital to the design of filament circuit. The present invention creatively adopts two capacitors C9, C10 and a resistor R3, which offer excellent pre-heating and protection for filament current in a dimming process, provide a channel to the alternate current so that no direct application is made to the filament to cause sputtering in order to realize pre-heating, and supply a suitable current to the filament in a low dimming voltage in order to maintain hot spot temperature of the filament and ensure the capability of emitting electrons from the cathode.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A dimmable compact fluorescent lighting device, comprising:
a safety protection circuit, which is connectable to an input line and comprises a fuse;
an electro-magnetic compatibility circuit, which achieves electro-magnetic compatibility;
a rectification and filter circuit;
a power factor correction circuit, which increases power factor, reduces peak current, and suppresses blinking occurring in a dimming process; and
a trigger circuit, a switching and anti-saturation circuit, a resonant circuit, and a filament pre-heating protection circuit, wherein the switching and anti-saturation circuit comprises a transformer, a capacitor, and two transistors, and the trigger circuit comprises a capacitor, so that when a voltage is applied through the safety protection circuit, the electro-magnetic compatibility circuit, the rectification and filter circuit, and the power factor correction circuit to supply a direct-current working voltage, the trigger circuit conducts and conduction conditions are satisfied to get a second transistor in conduction, electrical charge flowing from an emitter of a first transistor to a transformer primary side thereby showing a low potential to satisfy conduction conditions, meanwhile the transformer primary side within the switching and anti-saturation circuit causing discharging through a transformer secondary side, making a second transistor cutting off upon getting into conduction, the capacitor being recharged, the first transistor getting cut off due to rise of emitter potential, the capacitor of the trigger circuit being charged again, the second transistor of the switching and anti-saturation circuit satisfying the conduction conditions again for conducting, whereby an alternate current is caused to flow through the transformer primary side and induction voltages are induced in the secondary sides, forcing the two transistors to alternate conduct and thus inducing oscillation, which shows a frequency that when identical to a natural frequency of the resonant circuit generates resonance to achieve a high resonance voltage to start up a lighting tube.

2. The dimmable compact fluorescent lighting device according to claim 1, wherein the electro-magnetic compatibility circuit suppresses high order resonant wave and eliminates internal and external high frequency interference so as to allow the input circuit to suppress high frequency interference and also suppress discontinuity of current caused by low voltage.

3. The dimmable compact fluorescent lighting device according to claim 1, wherein the power factor correction circuit corrects non-sinusoidal wave voltages and high order resonant waves in order to provide a stable direct-current working voltage to a subsequent stage and to improve utilization of power and the power factor and also suppress blinking occurring in a dimming process.

4. The dimmable compact fluorescent lighting device according to claim 1, wherein the two transistors of the switching and anti-saturation circuit comprise built-in anti-saturation circuitry.

5. The dimmable compact fluorescent lighting device according to claim 1, wherein the filament pre-heating protection circuit comprises two capacitors and a resistor.
